(19) United States
(12) Patent Application Publication
(10) Pub. No.: US 2025/0273779 A1
(43) Pub. Date: Aug. 28, 2025

(54) ENERGY STORAGE ELEMENT AND MANUFACTURING PROCESS

(71) Applicant: VARTA Microbattery GmbH, Ellwangen Jagst (DE)

(72) Inventors: Edward PYTLIK, Ellwangen (DE); Michael GEIGER, Ellwangen (DE); Waldemar FRANK, Ellwangen (DE); David ENSLING, Ellwangen (DE)

(21) Appl. No.: 18/858,345

(22) PCT Filed: Apr. 20, 2023
(86) PCT No.: PCT/EP2023/060340

§ 371 Date: Oct. 21, 2024

(30) Foreign Application Priority Data
Apr. 22, 2022 (EP) 22169512.5

(51) Int. Cl. H01M 50/152; H01M 10/04; H01M 50/107; H01M 50/119; H01M 50/159; H01M 50/184; H01M 50/188; H01M 50/193; H01M 50/342; H01M 50/533; H01M 50/536; H01M 50/566

(52) U.S. Cl. CPC H01M 50/152; H01M 10/049; H01M 50/107; H01M 50/119; H01M 50/159; H01M 50/184; H01M 50/188; H01M 50/193; H01M 50/3425; H01M 50/533; H01M 50/536; H01M 50/566

(57) ABSTRACT

An energy storage element includes a housing having a metallic, cup-shaped housing part with a housing bottom and a lid component that closes a terminal opening of the cup-shaped housing part. The energy storage element further includes an electrode-separator assembly arranged in the housing, the electrode-separator assembly comprising a first flat terminal end face, a second flat terminal end face, an anode with an anode current collector having a first edge and a second edge parallel thereto, and a cathode with a cathode current collector having a first edge and a second edge parallel thereto. The housing bottom has an aperture closed by a metallic membrane that acts as a primary protection device against internal overpressure, and at least one groove on its inside or outside that acts as a secondary protection device against internal overpressure.

### CROSS REFERENCE TO RELATED APPLICATIONS

This application is a U.S. National Phase application under 35 U.S.C. § 371 of International Application No. PCT/EP2023/060340, filed on Apr. 20, 2023, and claims benefit to European Patent Application No. EP 22169512.5, filed on Apr. 22, 2022. The International Application was published in German on Oct. 26, 2023 as WO 2023/203155 under PCT Article 21(2).

### FIELD

The present disclosure relates to an energy storage element and to a manufacturing method.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, between which a separator is arranged. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte. The separator thus prevents direct contact between the electrodes. At the same time, however, it enables electrical charge equalization between the electrodes.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example.

Furthermore, the electrodes can comprise an electrode binder (e.g. polyvinylidene fluoride (PVDF) or another polymer, such as carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells usually comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly when manufacturing a lithium-ion cell. The electrodes and separators are often, but not necessarily, joined together under pressure, possibly by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in tools, lithium-ion cells with the highest possible energy density are required, which are also able to withstand high currents during charging and discharging.

Cells for the applications mentioned are often designed as cylindrical round cells, for example with a form factor of 21×70 (diameter*height in mm). Cells of this type always comprise an assembly in the form of a winding. Modern lithium-ion cells of this form factor can achieve an energy density of up to 270 Wh/kg.

WO 2017/215900 A1 describes cylindrical round cells in which the electrode-separator assembly and its electrodes are ribbon-shaped and in the form of a winding. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact sheet metal part that sits on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

Cylindrical round cells such as those in WO 2017/215900 A1 are usually used as part of a cell assembly in which several cells are connected together in series and/or parallel. It is often desirable to only have to contact the cells at one of their end faces in order to tap an electrical voltage. Accordingly, it is advantageous to provide both a connection pole connected to the positive electrode of the cell and a connection pole connected to the negative electrode of the cell on one of the end faces.

A lithium-ion round cell is known from US 2006/0019150 A1, which comprises an electrode-separator assembly formed as a winding in a cylindrical housing. The housing comprises a cylindrical housing cup made of metal with an opening that is closed by a metal lid component. The bottom of the housing cup is electrically connected to the positive electrode of the winding; the housing cup is therefore positively polarized. Both housing parts are in direct contact with each other, which is why the lid component is also positively polarized. A positive metallic connection pole is welded onto the lid component. The negative electrode of the winding, on the other hand, is connected to a negative metallic terminal pole, which is guided through an aperture in the lid component and is electrically insulated from the lid component. The positive and negative connection poles are thus arranged next to each other on the same side of the cell so that the cell can be easily integrated into a cell assembly via corresponding current conductors.

In addition to its good contactability, the cell described in US 2006/0019150 A1 is also characterized by an integrated overpressure protection. For this purpose, the bottom has a central, circular region which is separated from an annular residual region of the bottom by a circumferential weakening line and to which a bent arrester strip is welded on the inside, via which said electrical contact of the bottom to the positive electrode of the winding exists. In the event of overpressure inside the housing, the circular region can be blown out of the bottom. Since an annular insulator ensures that the annular residual area has no contact whatsoever with the electrode-separator assembly in the form of a winding, the electrical connection between the positive electrode and the annular residual area and all components in electrical contact with it, including the positive terminal pole, is interrupted.

The negative electrode of the winding is electrically contacted via a multiple bent arrester strip, the upper end of which is coupled to the negative terminal.

From an energy point of view, the design of the cell described in US 2006/0019150 A1 is not optimal. There is a dead volume at both ends of the winding, which must be bridged by the aforementioned arrester strips. These have a negative effect on the energy density of the cell.

### SUMMARY

In an embodiment, the present disclosure provides an energy storage element. The energy storage element includes an airtight and liquid-tight housing. The housing includes a metallic, cup-shaped housing part with a housing bottom, a circumferential side wall, and a terminal opening. The housing further includes a lid component that closes the terminal opening of the cup-shaped housing part, the lid component comprising a metallic lid plate and a connecting terminal guided through an aperture in the lid plate and electrically insulated from the lid plate. The energy storage element further includes an electrode-separator assembly arranged in the housing, the electrode-separator assembly comprising a first flat terminal end face, a second flat terminal end face, an anode with an anode current collector having a first edge and a second edge parallel thereto, and a cathode with a cathode current collector having a first edge and a second edge parallel thereto. The energy storage element additionally includes a contact sheet metal part that sits directly on the first edge of the anode current collector or on the first edge of the cathode current collector, the contact sheet metal part being electrically connected to the connecting terminal. The anode current collector comprises a main region loaded with a layer of negative electrode material and a free edge strip, extending along the first edge of the anode current collector, that is not loaded with the negative electrode material. The cathode current collector comprises a main region loaded with a layer of positive electrode material and a free edge strip, extending along the first edge of the cathode current collector, that is not loaded with the positive electrode material. The anode and the cathode are arranged within the electrode-separator assembly such that the first edge of the anode current collector protrudes from the first terminal end face and the first edge of the cathode current collector protrudes from the second terminal end face. The first edge of the cathode current collector or the first edge of the anode current collector, which is not in direct contact with the contact sheet metal part, is electrically connected to the housing bottom. The housing bottom has an aperture closed by a metallic membrane that acts as a primary protection device against internal overpressure, and the housing bottom has at least one groove on its inside or outside that acts as a secondary protection device against internal overpressure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic representation of the electrode ribbons and their arrangement to illustrate the structure of an electrode-separator assembly of an energy storage cell;

FIG. 2A-C provide illustrations of an energy storage cell from the outside and in a longitudinal section;

FIG. 3 provides detailed views of the upper and lower end face regions of an energy storage cell in a longitudinal section;

FIG. 4A-B provide detailed views of a connection pole for an energy storage cell in an oblique view from above and in a sectional view;

FIG. 5A-B provide detailed views of an insulating disk for an energy storage cell in an oblique view from above and in a sectional view;

FIG. 6A-B provide detailed views of a contact sheet metal part for an energy storage cell in an oblique view from above and in a sectional view oblique from below;

FIG. 7 provides a detailed view of the housing bottom of an energy storage cell;

FIG. 8A-C provide representations of the various components of an energy storage cell in exploded views;

FIG. 9A-B provide detailed illustrations from the upper end face region of an energy storage cell to illustrate a manufacturing process for the energy storage cell;

FIG. 10 provides an illustration of an energy storage cell viewed obliquely from above onto the housing bottom to illustrate a manufacturing process for the energy storage cell; and

FIG. 11A-B illustrate an alternative embodiment of a contact sheet metal part with an attached connection pole and its installation in an energy storage cell in sectional views.

### DETAILED DESCRIPTION

The present disclosure provides energy storage elements characterized by an improved energy density compared to the prior art and which can be efficiently processed into a cell assembly. Furthermore, the energy storage elements are also characterized by improved safety.

### Energy Storage Element

An energy storage element has the immediately following features a. to o:
a. It comprises an airtight and liquid-tight housing and an electrode-separator assembly arranged therein.
b. The housing comprises a metallic, cup-shaped housing part which has a housing bottom, a circumferential side wall and a terminal opening.
c. The housing comprises a lid component that closes the terminal opening of the cup-shaped housing part.
d. The lid component comprises a metallic lid plate and a connecting terminal which is guided through an aperture in the lid plate and is electrically insulated from the lid plate.
e. The electrode-separator assembly comprises a first flat terminal end face and a second flat terminal end face.
f. The electrode-separator assembly comprises an anode with an anode current collector having a first edge and a second edge parallel thereto.
g. The anode current collector comprises a main region loaded with a layer of negative electrode material and a free edge strip extending along its first edge which is not loaded with the electrode material.
h. The electrode-separator assembly comprises a cathode with a cathode current collector having a first edge and a second edge parallel thereto.
i. The cathode current collector comprises a main region loaded with a layer of positive electrode material and a free edge strip extending along its first edge which is not loaded with the electrode material.
j. The anode and the cathode are arranged within the electrode-separator assembly in such a way that the first edge of the anode current collector protrudes from the first terminal end face and the first edge of the cathode current collector protrudes from the second terminal end face of the electrode-separator assembly.
k. The energy storage element comprises a contact sheet metal part which sits directly on the first edge of the anode current collector or on the first edge of the cathode current collector.
l. The contact sheet metal part is electrically connected to the connecting terminal routed through the aperture in the lid plate.
m. The first edge of the cathode current collector or the anode current collector, which is not in direct contact with the contact sheet metal part, is electrically connected to the housing bottom.
n. The housing bottom of the cup-shaped housing part has a primary protection device against internal overpressure in the form of an aperture which is closed by means of a metallic membrane.
o. The housing bottom of the cup-shaped housing part has a secondary protection device against internal overpressure in the form of at least one groove on its inside or outside.

The advantage of such an energy storage element is that it is possible to make electrical contact with both the anode and the cathode via the lid component. As the aforementioned safety functions are not integrated in the lid component-as is the case with many classic cells-but instead in the housing bottom, it is also possible to build the lid component extremely compactly. It is also not absolutely necessary to pre-assemble the lid component. Instead, the lid component can be manufactured during housing assembly, as described in more detail below.

In preferred embodiments, the energy storage element is characterized by at least one of the features a. to e. immediately below:
a. The lid plate is welded into the terminal opening of the cup-shaped housing part.
b. The contact sheet metal part is connected to the first edge of the anode current collector or the first edge of the cathode current collector by welding.
c. The first edge of the anode current collector or the cathode current collector, which is not in direct contact with the contact sheet metal part, sits directly on the housing bottom.
d. The first edge of the anode current collector or the cathode current collector, which is not in direct contact with the contact sheet metal part, is connected to the housing bottom by welding.
e. At least one groove is located on the inside of the housing bottom.

Preferably, the immediately preceding features a. to d. are realized in combination, preferably the immediately preceding features a. to e.

The primary protection device has the function of bringing about a controlled pressure equalization if an impermissible overpressure occurs above a defined threshold value. In this case, the membrane is blown open or blown off by the pressure and gas formed inside the housing can escape through the aperture in the housing bottom.

The secondary protection device is intended for cases in which pressure equalization via the primary protection device does not occur quickly enough. In this case, the housing bottom can tear open due to the excess pressure along the groove, which is nothing more than a weakening of the structure of the housing bottom, creating an outlet opening with a comparatively large cross-section through which gas formed inside the housing can escape.

Such safety solutions are already known per se. The pressure at which the protection devices are triggered can be set precisely by designing the groove and membrane appropriately.

In many cases, it is preferred that the cup-shaped housing part is positively polarized and the connection pole is a negative connection pole. In these cases, the energy storage element is characterized by the feature a. immediately below, optionally in combination with at least one other of the features b. to e. immediately below:
a. The cup-shaped housing part is electrically connected to the cathode.
b. The contact sheet metal part sits on the first edge of the anode current collector and is connected to it by welding.
c. The cup-shaped housing part consists of aluminum or an aluminum alloy.
d. The lid plate consists of aluminum or an aluminum alloy.
e. The contact sheet metal part is in direct contact with the connecting pole which is guided through the aperture in the lid plate and is preferably connected to it by welding.

The immediately preceding features a. to e. are preferably realized in combination.

In this embodiment, the housing of the energy storage element consists of substantial parts made of aluminum or an aluminum alloy. This has various advantages. The formation of localized elements when the outside of the cell comes into contact with moisture is excluded. The housing itself can basically serve as a positive connection pole on all its sides. However, it is preferable for the cell to be contacted exclusively via the lid component, where the negative connection pole is also located. For this purpose, a current arrester can be welded directly to the lid plate or alternatively fixed to the separate connection pole, for example by welding.

Suitable aluminum alloys for the cup-shaped housing part and the lid plate are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

In further cases, it may be preferred that the cup-shaped housing part is negatively polarized and the connection pole is a positive connection pole. In these cases, the energy storage element is characterized by the feature a. immediately below, optionally in combination with at least one other of the features b. to e. immediately below:
a. The cup-shaped housing part is electrically connected to the anode.
b. The contact sheet metal part sits on the first edge of the cathode current collector and is connected to it by welding.
c. The cup-shaped housing part consists of copper or nickel or a copper or nickel alloy or steel or nickel-plated steel.
d. The lid plate consists of copper or nickel or a copper or nickel alloy or steel or nickel-plated steel.
e. The contact sheet metal part is in direct contact with the connecting pole which is guided through the aperture in the lid plate and is preferably connected to it by welding. The immediately preceding features a. to e. are preferably realized in combination.

In this embodiment, the housing of the energy storage element consists of essential parts made of copper or nickel or a copper or nickel alloy or steel or nickel-plated steel.

Suitable stainless steels are, for example, stainless steels of type 1.4303 or 1.4404 or of type SUS304 or nickel-plated steels. In particular, materials of type EN CW-004A or EN CW-008A with a copper content of at least 99.9% can be used as copper alloys. Nickel alloys of the type NiFe, NiCu, CuNi, NiCr and NiCrFe are suitable.

### Preferred Design of the Housing Bottom

In preferred embodiments, the energy storage element is characterized by at least one of the features a. to f. immediately below:
a. The housing bottom has at least one bead which appears on its outer side as an elongated depression and on its inner side as an elongated elevation, with the first edge of the anode current collector or the first edge of the cathode current collector resting on the inner side.
b. The housing bottom is welded to the first edge of the anode current collector or the first edge of the cathode current collector in the region of the bead.
c. The aperture is positioned in the center of the housing bottom.
d. The at least one bead comprises several linear beads, in particular three beads, which are arranged in a star-shaped arrangement around the aperture.
e. The at least one groove comprises several linear partial sections which are arranged in a star-shaped arrangement around the aperture.
f. The at least one groove comprises a partial section running around the aperture, which connects the linear partial sections arranged in a star shape.

Preferably, the immediately preceding features a. and b., c. and d. as well as c. and e. and f. are realized in combination. Preferably, the immediately preceding features a. to f. are realized in combination

As a result of the welding in the region of the bead, there are preferably one or more weld seams in the bead. The star-shaped beads and the star-shaped linear partial sections of the groove each preferably form an angle of 120°.

In some embodiments, it has proven advantageous to subject the edge of the current collector, which sits on the inside of the housing bottom, to a pre-treatment so that the contact between the housing bottom and the current collector is improved. In particular, at least one depression can be folded into the edge, which corresponds to the at least one bead or the elongated elevation on the flat side of the contact sheet metal part facing the first terminal end face.

The edge of the current collector may also have been subjected to directional forming by pre-treatment. For example, it can be bent in a defined direction.

In some embodiments, the bottom of the cup-shaped housing part is welded in, i.e. manufactured separately and assembled to the side wall by welding. In most cases, however, the cup-shaped housing part is manufactured by deep drawing.

### Prismatic Embodiment

In preferred embodiments, the energy storage element is prismatic or designed as a cylindrical round cell or as a button cell.

In this embodiment, the housing is prismatic. In this embodiment, the bottom of the cup-shaped housing part and the lid component preferably have a polygonal, preferably a rectangular base. The shape of the terminal opening of the cup-shaped housing part corresponds to the shape of the bottom and the lid component. In addition, the housing comprises several, preferably four, rectangular side parts which connect the bottom and the lid component to one another.

In this embodiment, the electrode-separator assembly is preferably also prismatic. In this case, the electrode-separator assembly is preferably a prismatic stack of several anodes, cathodes and at least one separator, whereby the electrode-separator assembly within the stack always has the sequence anode/separator/cathode.

At least the anodes and cathodes preferably have a rectangular base surface, wherein the current collectors of the anodes and cathodes each have the first edge and the second edge parallel thereto and each have the free edge strip along their first edge, which is not coated with the respective electrode material.

In the case of several separators between the anodes and cathodes, the separators preferably also have a rectangular base area. However, it is also possible to use a ribbon-shaped separator that separates several anodes and cathodes within the stack.

The first and second flat terminal end faces of the stack are, for example, two opposite or adjacent sides of the stack. The first edges of the anode current collectors protrude from one of these end faces and the first edges of the cathode current collectors protrude from the other. The contact sheet metal part sits on the first edges of the anode current collectors and is assembled to them by welding.

### Embodiment as a Cylindrical Round Cell or as a Button Cell

In this embodiment, the energy storage element is preferably characterized by at least one of the features a. to p. immediately below:
a. The terminal opening of the cup-shaped housing part is circular and the circumferential side wall of the cup-shaped housing part comprises or forms a cylindrical housing shell.
b. The lid component, which closes the circular opening of the cup-shaped housing part, has a circular circumference.
c. The electrode-separator assembly is in the form of a cylindrical winding which, in addition to the first and second flat terminal end faces, has a winding shell located between the end faces.
d. In the housing, the electrode-separator assembly is axially aligned so that the winding shell rests against the inside of the cylindrical housing shell.
e. The anode and the anode current collector are ribbon-shaped, with the anode current collector comprising a first longitudinal edge and a second longitudinal edge and two ends.
f. The first and the parallel second edge of the anode current collector are the longitudinal edges of the ribbon-shaped anode current collector.
g. The main region of the anode current collector, which is loaded with a layer of negative electrode material, is strip-shaped.
h. The free edge strip extends along the first longitudinal edge of the anode current collector.
i. The cathode and the cathode current collector are ribbon-shaped, the cathode current collector comprising a first longitudinal edge and a second longitudinal edge and two ends.
j. The first and the parallel second edge of the cathode current collector are the longitudinal edges of the ribbon-shaped cathode current collector.
k. The main region of the cathode current collector, which is loaded with a layer of positive electrode material, is strip-shaped.
l. The free edge strip extends along the first longitudinal edge of the cathode current collector.
m. The separator or separators of the electrode-separator assembly are ribbon-shaped.
n. The anode and the cathode are arranged within the electrode-separator assembly in such a way that the first longitudinal edge of the anode current collector protrudes from the first terminal end face and the first longitudinal edge of the cathode current collector protrudes from the second terminal end face of the electrode-separator assembly.
o. The contact sheet metal part sits on the first longitudinal edge of the anode current collector or on the first edge of the cathode current collector and is connected to it by welding.
p. The first longitudinal edge of the anode current collector or the cathode current collector, which is not in direct contact with the contact sheet metal part, is electrically connected to the housing bottom.

Preferably, the energy storage element is characterized by a combination of all the immediately preceding features a. to p.

In this embodiment, the electrode-separator assembly preferably comprises a ribbon-shaped separator or two ribbon-shaped separators, each of which has a first and a second longitudinal edge and two ends. The electrode-separator assembly comprises the electrodes and the separator or separators always with the sequence anode/separator/cathode.

In this embodiment, the lid component with the circular circumference is preferably arranged in the circular opening of the cup-shaped housing part in such a way that its edge rests against the inside of the cup-shaped housing part along a circumferential contact zone, the edge of the lid component being joined to the cup-shaped housing part by a circumferential weld seam.

Preferably, the height of energy storage elements designed as cylindrical round cells is in a range from 50 mm to 150 mm. The diameter of the cylindrical round cells is preferably in a range from 15 mm to 60 mm. Cylindrical round cells with these form factors are suitable for supplying power to electric drives in motor vehicles.

If the energy storage element is designed as a button cell, it preferably has a diameter of up to 25 mm and a height of up to 15 mm.

In embodiments in which the cell is a cylindrical round cell, the anode current collector, the cathode current collector and the separator or separators preferably have the following dimensions:
A length in a range from 0.5 m to 25 m
A width in a range from 30 mm to 145 mm

The free edge strip, which extends along the first longitudinal edge and which is not loaded with the electrode material, preferably has a width of no more than 5000 μm in these cases.

### Preferred Embodiments of the Separator

Preferably, the separator or separators are formed from electrically insulating plastic films. It is preferable that the separators can be penetrated by the electrolyte. For this purpose, the plastic films used can have micropores, for example. The film can consist of a polyolefin or a polyether ketone, for example. Nonwovens and fabrics made of plastic materials or other electrically insulating fabrics can also be used as separators. Separators with a thickness in a range from 5 μm to 50 μm are preferred.

In some preferred embodiments, separators are used which are coated or impregnated with ceramic particles (e.g. Al₂O₃ or SiO₂) on one or both sides.

Particularly in the prismatic embodiments of the energy storage element, the separator or separators of the assembly can also be one or more layers of a solid electrolyte.

### Preferred Structure of an Electrode-Separator Assembly in the Form of a Winding

The ribbon-shaped anode, the ribbon-shaped cathode and the ribbon-shaped separator(s) are preferably spirally wound in the electrode-separator assembly formed as a winding. To produce the ribbon-shaped electrode-separator assembly, the ribbon-shaped electrodes are preferably fed to a winding device together with the ribbon-shaped separator(s) and are preferably spirally wound around a winding axis in the winding device. In some embodiments, the electrodes and the separator are wound onto a cylindrical or hollow-cylindrical winding core for this purpose, which is seated on a winding mandrel and remains in the winding after winding.

The winding shell can be formed by a plastic film or an adhesive tape, for example. It is also possible for the winding shell to be formed by one or more separator windings.

### Preferred Electrochemical Embodiment

In a further preferred embodiment, the energy storage element is characterized by one of the features a. and b. immediately below:
a. The energy storage element is a lithium-ion cell.
b. The energy storage element comprises a lithium-ion cell.

Feature a. refers in particular to the described embodiment of the energy storage element as a cylindrical round cell or button cell. In this embodiment, the energy storage element preferably comprises or is exactly one electrochemical cell.

Feature b. refers in particular to the described prismatic embodiment of the energy storage element. In this embodiment, the energy storage element may also comprise more than one electrochemical cell.

Basically, all electrode materials known for secondary lithium-ion cells can be used for the electrodes of the energy storage element.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity for the receptability of lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM—O compounds and/or mixtures of the aforementioned materials can also be used. The cathodic active materials are also preferably used in particulate form.

In addition, the electrodes of an energy storage element preferably contain an electrode binder and/or an additive to improve the electrical conductivity. The active materials are preferably embedded in a matrix of the electrode binder, with neighboring particles in the matrix preferably being in direct contact with each other. Conductive agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

The energy storage element preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THE or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The nominal capacity of a lithium-ion-based energy storage element designed as a cylindrical round cell is preferably up to 15000 mAh. With the form factor of 21×70, the energy storage element in an embodiment as a lithium-ion cell preferably has a nominal capacity in a range from 1500 mAh to 7000 mAh, preferably in a range from 3000 to 5500 mAh. With the form factor of 18×65, the cell in an embodiment as a lithium-ion cell preferably has a nominal capacity in a range from 1000 mAh to 5000 mAh, preferably in a range from 2000 to 4000 mAh.

In the European Union, manufacturers' information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### Further Preferred Electrochemical Embodiment

Alternatively, the energy storage cell may also be a sodium-ion cell, a potassium-ion cell, a calcium-ion cell, a magnesium-ion cell or an aluminum-ion cell. In further possible embodiments, the energy storage cell comprises a sodium-ion cell, a potassium-ion cell, a calcium-ion cell, a magnesium-ion cell or an aluminum-ion cell. Among these variants, energy storage cells with sodium ion cell chemistry are preferred.

The negative electrode material of an energy storage element based on sodium ions is, for example, one of the following materials:
carbon, especially hard carbon (pure or with nitrogen and/or phosphorus doping) or soft carbon or graphene-based materials, carbon nanotubes, graphite
phosphorus or sulphur
polyanions such as Na₂Ti₃O₇, Na₃Ti₂(PO₄)₃, TiP₂O₇, TiNb₂O₇, Na—Ti—(PO₄)₃, Na—V—(PO₄)₃

Transition metal oxides such as V₂O₅, MnO₂, TiO₂, Nb₂O₅, Fe₂O₃, Na₂Ti₃O₇, NaCrTiO₄, Na₄Ti₅O₁₂

Alternatively, a Na metal anode can also be used on the anode side.

The positive electrode material of an energy storage element based on sodium ions is, for example, one of the following materials:

Polyanions: NaFePO₄ (triphylite type), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, NaCoPO₄, Na₂CoPO₄F

Silicates: Na₂MnSiO₄, Na₂FeSiO₄

Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

As with lithium-ion cells, electrodes based on sodium ions can also comprise an electrode binder and/or an additive to improve electrical conductivity. Suitable electrode binders are based, for example, on polyvinylidene fluoride (PVDF), (Li-)polyacrylate, styrene-butadiene rubber or carboxymethyl cellulose or mixtures of different binders. Suitable conductive agents are carbon black, fine graphite, carbon fibers, carbon nanotubes and metal powder.

An energy storage cell based on sodium ions preferably comprises an electrolyte comprising at least one of the following solvents and at least one of the following conducting salts:
Organic carbonates, ethers, nitriles and mixtures thereof are suitable as solvents.
Preferred conducting salts are NaPF₆, Sodium-difluoro (oxalato) borat (NaBOB), NaBF₄, Natriumbis(fluorosulfonyl)imid (NaFSI), Natrium-2-trifluoromethyl-4,5-dicyanoimidazol (NaTDI), Natrium-bis(trifluoromethansulfonyl)imid (NaTFSI), NaAsF₆, NaBF₄, NaClO₄, NaB(C₂O₄)₂, NaP(C₆H₄O₂)₃; NaCF₃SO₃, Natriumtriflat (NaTf) und Et₄NBF₄.

In preferred embodiments, additives may be added to the electrolyte.

### Preferred Embodiments of the Current Collectors

The current collectors of the energy storage element have the function of electrically contacting the electrochemically active components contained in the respective electrode material over as large an area as possible. Preferably, the current collectors consist of a metal or are at least metallized on the surface.

In the case of an energy storage element designed as a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are suitable as nickel alloys. Alloys of the type NiFe, NiCu, CuNi, NiCr and NiCrFe are suitable as nickel alloys. Stainless steel can also be considered, for example type 1.4303 or 1.4404 or type SUS304.

In the case of an energy storage element designed as a lithium-ion cell, aluminum or other electrically conductive materials, including aluminum alloys, are suitable as the metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

In the case of a sodium-ion cell, in preferred embodiments, both the cathode current collector and the anode current collector consist of aluminum or an aluminum alloy.

Preferably, the anode current collector and/or the cathode current collector are each a metal foil with a thickness in the region of 4 μm to 30 μm, in the case of the described configuration of the energy storage element as a cylindrical round cell, a ribbon-shaped metal foil with a thickness in a range from 4 μm to 30 μm.

In addition to films, however, other strip-shaped substrates such as metallic or metallized nonwovens or open-pored metallic foams or expanded metals can also be used as current collectors.

The current collectors are preferably loaded with the respective electrode material on both sides.

In the case of the described configuration of the energy storage element as a cylindrical round cell, it is preferred that the longitudinal edges of the separator or separators form the end faces of the electrode-separator assembly, which is formed as a winding.

In the case of the described prismatic configuration of the energy storage element, it is preferred that the edges of the separator(s) form the end faces of the stack from which the edges of the current collectors protrude.

It is further preferred that the longitudinal edges or edges of the anode current collector and/or the cathode current collector protruding from the terminal end faces of the winding or sides of the stack do not exceed 5000 μm, preferably not more than 3500 μm.

Preferably, the edge or the longitudinal edge of the anode current collector protrudes from the side of the stack or the end face of the winding by no more than 2500 μm, preferably by no more than 1500 μm. Preferably, the edge or the longitudinal edge of the cathode current collector protrudes from the side of the stack or the end face of the winding by no more than 3500 μm, preferably by no more than 2500 μm.

### Preferred Embodiments of the Lid Component

In preferred embodiments, the energy storage element is characterized by at least one of the features a. to d. immediately below:
a. The connection pole sits directly on the contact sheet metal part and is connected to it by welding.
b. The connection pole is electrically insulated from the lid plate by a hardened potting compound made of an electrically insulating plastic material.
c. There is an annular gap between the lid plate and the contact sheet metal part, which is filled with the potting compound.
d. The annular gap is limited radially outwards by an O-ring-shaped insulating washer made of an electrically insulating plastic material.

Preferably, the energy storage element is characterized by a combination of all the immediately preceding features a. to d.

A lid component of this design ensures that there is essentially no dead volume at all between the electrode-separator assembly and the metal lid plate. Any space between the contact sheet metal part, the connection pole, the lid plate and, if applicable, the O-ring-shaped insulating disk can be filled with the potting compound. A lid component with the features mentioned can be built very compactly.

In a further development of an energy storage element, in which the cup-shaped housing part has a positive pole and the connection pole is a negative connection pole, the energy storage element is characterized by the following features a. to e. immediately below:
a. The connection pole sits directly on the contact sheet metal part and is connected to it by welding.
b. The contact sheet metal part consists of nickel or copper or titanium or a nickel or copper or titanium alloy or stainless steel.
c. The terminal pole is a bimetallic terminal pole and comprises a lower pole part made of nickel or copper or titanium or a nickel or copper or titanium alloy or stainless steel and an upper pole part made of aluminum or an aluminum alloy.
d. The lower part of the pole is welded to the contact sheet metal part.
e. The lower part of the pole and the contact sheet metal part and the anode current collector consist of the same material.

Preferably, the energy storage element is characterized by a combination of the immediately preceding features a. to d., and in some embodiments also by a combination of all the immediately preceding features a. to e.

In this embodiment, the energy storage element is thus characterized by a connection pole comprising two different metallic materials, on one side nickel or copper or titanium or the nickel or copper or titanium alloy or stainless steel and on the other side aluminium or the aluminium alloy.

It is thus possible to build energy storage elements whose housing exterior is made entirely of aluminum or an aluminum alloy.

The upper pole section is accessible from the outside and can be welded to an aluminum conductor, for example. Such energy storage elements offer the significant advantage that they can be easily integrated into a cell assembly. In this case, the poles of several energy storage elements are interconnected via a common current conductor. In terms of production technology, it can be advantageous to weld the poles of the cells to the current conductor using a laser. This is generally only possible without problems if the materials to be welded are the same. For example, it is difficult or impossible to weld a copper terminal pole to an aluminum conductor using a laser. With the pole top part made of aluminum or the aluminum alloy, however, this is possible without any problems. This means that even negative connection poles of a cell can be assembled by laser via a common aluminum conductor.

Suitable aluminum alloys are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of said alloys is preferably above 99.5%. Suitable stainless steels are, for example, stainless steels of type 1.4303 or 1.4404 or of type SUS304 or nickel-plated steels. In particular, materials of type EN CW-004A or EN CW-008A with a copper content of at least 99.9% can be used as copper alloys. Nickel alloys of the type NiFe, NiCu, CuNi, NiCr and NiCrFe are suitable.

In a further development of an energy storage element, in which the cup-shaped housing part has a negative pole and the connection pole is a positive connection pole, the energy storage element is characterized by the following features a. to d immediately below:
a. The connection pole sits directly on the contact sheet metal part and is connected to it by welding.
b. The contact sheet metal part consists of aluminum or an aluminum alloy.
c. The connection pole consists of aluminum or an aluminum alloy.
d. The contact sheet metal part and the connecting pole and cathode current collector consist of the same material.

Preferably, the energy storage element is characterized by a combination of the immediately preceding features a. to c., in some embodiments also by a combination of all the immediately preceding features a. to d.

It is thus also possible in this embodiment to build energy storage elements whose housing exterior is made entirely of aluminum or an aluminum alloy.

### Preferred Embodiments of the Contact Sheet Metal Part/Connection of The Contact Sheet Metal Part to the Anode Current Collector and the Negative Terminal Pole or to the Cathode Current Collector and the Positive Terminal Pole

The contact sheet metal part is electrically connected to the connection pole, which passes through the aperture in the lid plate, and either to the anode current collector or to the cathode current collector. In particular, it is welded directly to the connecting pole and/or the respective current collector.

In a preferred embodiment, in which the cup-shaped housing part is positively polarized and the connection pole is a negative connection pole, the contact sheet metal part electrically connected to the negative connection pole is characterized by at least one of the features a. to c. immediately below:
a. The contact sheet metal part consists of nickel or copper or titanium or a nickel or copper or titanium alloy or stainless steel, for example of type 1.4303 or 1.4404 or of type SUS304, or of nickel-plated copper.
b. The contact sheet metal part consists of the same material as the negative connection pole or as the lower pole section of the negative connection pole.
c. The contact sheet metal part consists of the same material as the anode current collector.

It is preferred that the immediately preceding features a. and b., and preferably also features a. to c., are realized in combination with one another.

In a preferred embodiment, in which the cup-shaped housing part is negatively polarized and the connection pole is a positive connection pole, the contact sheet metal part electrically connected to the positive connection pole is characterized by at least one of the features a. to c. immediately below:
a. The contact sheet metal part consists of aluminum or an aluminum alloy.
b. The contact sheet metal part consists of the same material as the positive terminal.
c. The contact sheet metal part consists of the same material as the cathode current collector.

It is preferred that the immediately preceding features a. and b., preferably also features a. to c., are realized in combination with one another.

If the contact sheet metal part consists of the same material as the positive terminal and/or the cathode current collector, these components can be welded without any problems.

Suitable aluminum alloys for the contact sheet metal part include Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

In possible preferred further developments, the contact sheet metal part is characterized by at least one of the features a. to f. immediately below:
a. The contact sheet has a preferably uniform thickness in the region of 50 μm to 600 μm, preferably in the region of 150 um to 350 μm.
b. The contact sheet metal part has two opposite flat sides and extends essentially in only one dimension.
c. The contact sheet metal part is a disk or a polygonal plate.
d. The contact sheet metal part is dimensioned such that it covers at least 40% of the end face, preferably at least 60%, preferably at least 80%, of the end face from which the edge of the current collector on which it rests protrudes.
e. The contact sheet metal part has at least one bead which appears on one flat side of the contact sheet metal part as an elongate depression and on the opposite flat side as an elongate elevation, the contact sheet metal part resting with the flat side which carries the elongate elevation on the first edge of the anode current collector or on the first edge of the cathode current collector.
f. The contact sheet metal part is welded to the first edge of the anode current collector or the first edge of the cathode current collector in the region of the bead.

It is preferred that the immediately preceding features a. to c., preferably the immediately preceding features a. to d., are realized in combination with each other. In a preferred embodiment, features a. to d. are realized in combination with features e. and f.

Covering as much of the end face as possible is important for the thermal management of the energy storage element. The larger the cover, the easier it is to contact the first edge of the respective current collector over its entire length. Heat formed in the electrode-separator assembly can thus be dissipated well via the contact sheet metal part.

In some embodiments, it has proven advantageous to subject the edge of the respective current collector, on which the contact sheet metal part is placed, to a pretreatment prior to placing the contact sheet metal part, analogous to the pretreatment of the current collector seated on the housing bottom. In particular, at least one depression can also be folded into the edge here, which corresponds to the at least one bead or the elongated elevation on the flat side of the contact sheet metal part facing the first terminal end face.

The edge of the current collector may also have been subjected to directional forming by pre-treatment. For example, it can be bent in a defined direction.

In some preferred embodiments, the contact sheet metal part is pressed into the end face of the winding. In this case, the at least one bead is not required. In these cases, the contact sheet metal part is preferably polygonal or strip-shaped and preferably covers at least 50%, preferably at least 80%, of the end face into which it is pressed.

### Membrane in the Housing Bottom (Primary Protection Device)

In a further preferred embodiment, the energy storage element is characterized by the following feature a:
a. The metallic membrane is fixed to the bottom of the cup-shaped housing part by welding.

The bottom of the cup-shaped housing part can have a shallow depression into which the membrane is inserted so that it does not protrude. Preferably, it is connected to the bottom via a circular weld seam that runs around the aperture in the bottom.

The thickness of the membrane can be adjusted to the pressure at which the protection device is to be triggered.

### Preferred Design of the Housing Parts

In a further preferred embodiment, the energy storage element is characterized by at least one of the features a. to c. immediately below:
a. The bottom of the cup-shaped housing part has a thickness in a range from 200 μm to 2000 μm.
b. The side wall of the cup-shaped housing part has a thickness in a range from 150 μm to 2000 μm.
c. The lid component, in particular the lid plate of the lid component, has a thickness in a range from 200 μm to 2000 μm.

The immediately preceding features a. to c. are preferably realized in combination.

### Method

The method is used to manufacture the energy storage element and is characterized by the following steps a. to e:
a. Provision of a metallic, cup-shaped housing part comprising a housing bottom, a circumferential side wall and a terminal opening,
b. Provision of an electrode-separator assembly comprising
a cathode with a cathode current collector that has a first edge and a second edge parallel to it,
an anode with an anode current collector having a first edge and a second edge parallel thereto, and
a first flat terminal end face (and a second flat terminal end face
wherein
the anode current collector comprises a main region which is loaded with a layer of negative electrode material and a free edge strip which extends along its first edge and which is not loaded with the electrode material,
wherein
the cathode current collector comprises a main region which is loaded with a layer of positive electrode material and a free edge strip which extends along its first edge and which is not loaded with the electrode material,
wherein
the anode and the cathode are arranged within the electrode-separator assembly in such a way that the first edge of the anode current collector protrudes from the first terminal end face and the first edge of the cathode current collector protrudes from the second terminal end face of the electrode-separator assembly,
c. Inserting the electrode-separator assembly into the housing cup so that the first edge of the anode current collector or the first edge of the cathode current collector rests on the housing bottom.
d. Making a welded connection between the first edge resting on the housing bottom and the housing bottom, wherein
e. in the housing bottom of the cup-shaped housing part
a primary protection device against internal overpressure in the form of an aperture which is closed by means of a metallic membrane, and
a secondary protection device against internal overpressure in the form of at least one groove on its inside or outside is integrated.

The components used in the method have all been described in connection with the energy storage element. Reference is hereby made to the corresponding explanations.

As already explained above, it is preferred that either the first edge of the anode current collector or the first edge of the cathode current collector sits directly on the housing bottom. Furthermore, it is preferred that the edge resting on the housing bottom is connected to the housing bottom by welding.

The welded joint in step d. is preferably produced by welding, in particular laser welding, from the outside.

In preferred embodiments, the method comprises at least one of the immediately following steps a. and b.:
a. A contact sheet metal part is positioned on the first edge of the anode current collector or the first edge of the cathode current collector that does not rest on the housing bottom and is connected to this edge by welding.
b. One connection pole is fixed to the contact sheet metal part.

Preferably, the method comprises both steps a. and b.

Both step a. and step b. can be carried out before or after inserting the electrode-separator assembly into the housing cup. The connection pole is also fixed to the contact sheet metal part by welding.

Preferably, the method comprises the following two steps a. and b.:
a. A lid plate with an aperture for the connection pole is inserted into the terminal opening of the cup-shaped housing part.
b. A gap remaining between the lid plate and the contact sheet metal part is filled with a potting compound which, when hardened, electrically insulates the lid plate from the connecting terminal and from the contact sheet metal part.

With these steps, the housing of the energy storage element is formed and simultaneously sealed on its top side. It is preferred that the lid plate is welded to the cup-shaped housing part before step b. This measure, in combination with the application of the potting compound in step b., ensures the liquid-and gas-tight closure of the housing.

In preferred embodiments, the above-mentioned O-ring-shaped insulating washer made of an electrically insulating plastic material is placed on the contact sheet metal part before the lid plate is inserted. It limits the gap to be filled with potting compound radially to the outside.

The electrode-separator assembly can be impregnated with a suitable electrolyte via the aperture in the housing bottom of the metallic, cup-shaped housing part. The aperture can then be closed by means of the metallic membrane.

Further features and advantages are apparent from the claims and from the following description of preferred examples in conjunction with the drawings. The individual features may be realized individually or in combination with each other.

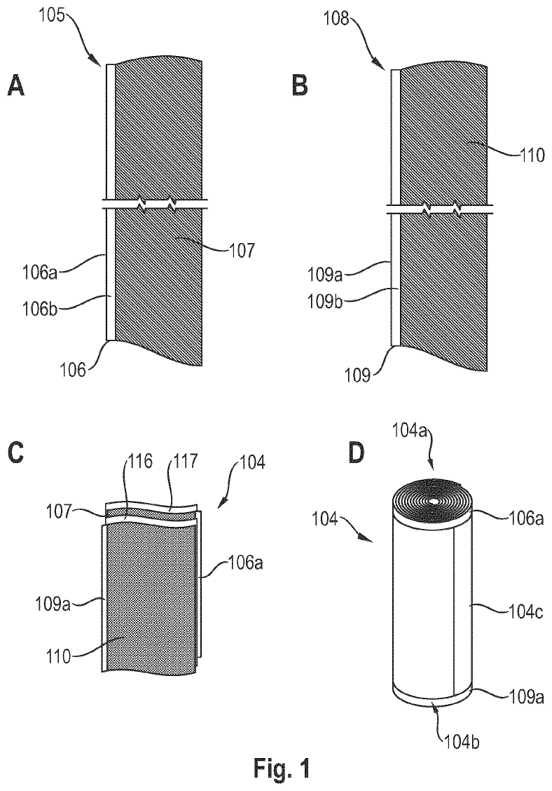

The ribbon-shaped electrode-separator assembly illustrated in FIG. 1A-D comprises the ribbon-shaped anode 105 (FIG. 1A) with the ribbon-shaped anode current collector 106, which has a first longitudinal edge 106a and a second longitudinal edge parallel thereto. The anode current collector 106 is preferably a foil made of copper or nickel. This comprises a strip-shaped main region, which is loaded with a layer of negative electrode material 107, and a free edge strip 106b, which extends along its first longitudinal edge 106a and which is not loaded with the electrode material 107. Furthermore, the electrode-separator assembly comprises the ribbon-shaped cathode 108 (FIG. 1B) with the ribbon-shaped cathode current collector 109, which has a first longitudinal edge 109a and a second longitudinal edge parallel thereto. The cathode current collector 109 is preferably an aluminum foil. It comprises a strip-shaped main region, which is loaded with a layer of positive electrode material 110, and a free edge strip 109b, which extends along its first longitudinal edge 109a and which is not loaded with the electrode material 110. Both electrodes are shown individually in an unwound state in FIG. 1A and B.

The anode 105 and the cathode 108 are arranged offset from each other within the electrode-separator assembly, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement is shown in FIG. 1C. The two ribbon-shaped separators 116 and 117 are also shown there, which separate the electrodes 105 and 108 from each other in the winding. In FIG. 1D, the electrode-separator assembly is shown in wound form, as it can be used in an energy storage element. The electrode edges 106a, 109a protruding from the end faces 104a, 104b are clearly visible. The outer winding shell 104c is formed by a plastic film.

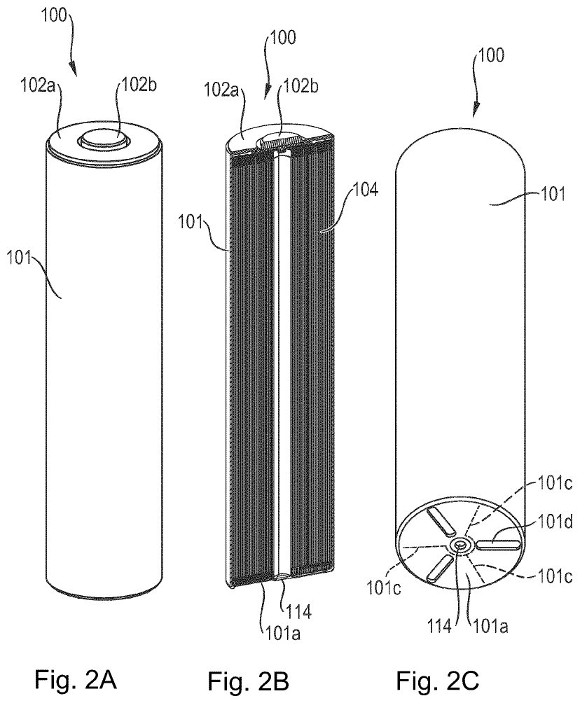

FIG. 2A-C shows an energy storage cell in an oblique view from above (FIG. 2A), in a longitudinal section (FIG. 2B) and in an oblique view from below (FIG. 2C). The energy storage cell 100 has the shape of a cylindrical round cell. The housing of the energy storage cell 100 is formed by a cup-shaped housing part 101 and a lid component. The lid component comprises a lid plate 102a, which has the shape of a perforated plate, and a connection pole 102b in the center of the lid component.

As can be seen in the sectional view in FIG. 2B, the winding-shaped electrode-separator assembly 104, which is formed from the wound electrode ribbons with separator ribbons in between, is located inside the energy storage cell 100.

FIG. 2C shows the bottom side of the energy storage cell 100, which is formed by the housing bottom 101a. In the housing bottom 101a, three star-shaped welded embossings are arranged in the form of beads 101d, which appear on the outside as a depression and on the inside as an elongated elevation. The longitudinal edge of the respective current collector sits on the inside of these beads 101d and the current collector is preferably welded directly to the housing bottom in the region of these beads.

The material for the housing bottom 101a and the entire cup-shaped housing part 101 is preferably aluminum.

Two safety functions are integrated into the housing bottom 101a. Firstly, there is an aperture in the center of the housing bottom 101a, which is closed by a metallic membrane 114. In the event of an overpressure occurring due to a malfunction of the cell, pressure equalization is brought about by means of this membrane 114, in which case the membrane is either blown open or blown off by the pressure. In this way, any gas that may have formed inside the cell can escape through the aperture in the housing bottom 101a (primary protection device).

In addition, a further safety function is provided in the housing bottom 101a, which is realized by three grooves 101c arranged in a star shape. These grooves 101c represent weakenings of the structure of the housing bottom 101a and thus form predetermined breaking points in the event of overpressure occurring inside the cell (secondary protection device). In this example, the grooves are located on the inner side of the housing bottom 101a and are therefore shown as dashed lines in FIG. 2C. In particular, the grooves 101c can be realized as three scoring lines. The star-shaped arrangement of the scoring lines is furthermore formed by a semi-circular connection of the scoring lines or the grooves 101c. At a correspondingly high overpressure, the housing bottom 101a tears open along the grooves 101c and the semi-circular connection of these grooves, so that an outlet opening with a comparatively large cross-section is created, through which any gas formed inside the housing can escape quickly.

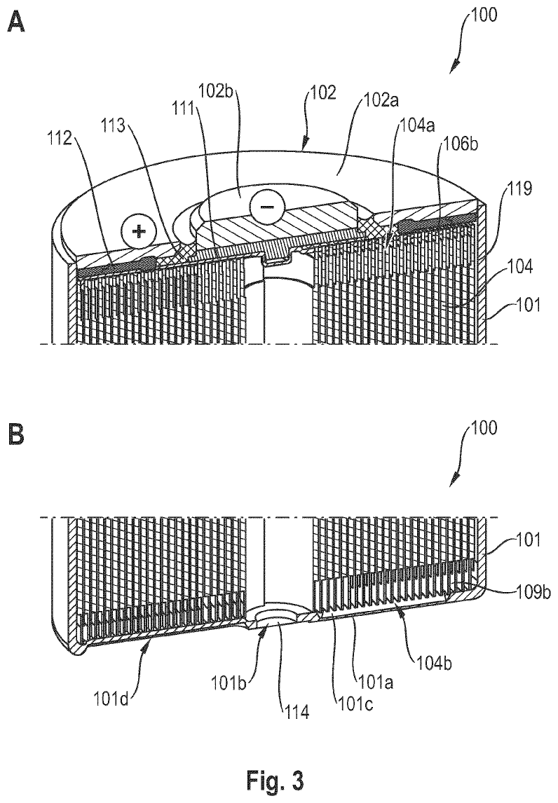

FIG. 3A,B shows an enlarged view of the end face regions of the energy storage cell 100. FIG. 3A shows details of the end face with the lid component 102. The lid component 102 comprises the lid plate 102a with a central aperture and with the connection pole 102b arranged in the center of the lid plate 102a. In this example, the connection pole 102b forms the negative pole and the surrounding lid plate 102a forms the positive pole of the energy storage cell 100.

Below the connecting pole 102b is the contact sheet metal part 111, which sits on the free edge strip 106b of the spirally arranged anode current collector of the negative electrode and is welded to it. The contact sheet metal part 111 is electrically connected to the connecting terminal 102b, which is formed from two metallic components, in particular by welding. The lid plate 102a is electrically insulated from the contact sheet metal part 111 by an O-ring-shaped insulating disk 112. Furthermore, an electrically insulating potting compound 113 is located in a gap between the connection pole 102b and the lid plate 102a.

FIG. 3B shows details of the opposite end face of the energy storage cell 100, which is comprised by the housing bottom 101a. The free edge strip 109b of the cathode current collector is electrically connected, in particular welded, directly to the housing bottom 101a on this end face of the energy storage cell 100. There is electrical contact with the metal lid plate 102a on the opposite end face via the shell of the cup-shaped housing part 101, so that the positive potential of the cell can also be tapped on the upper end face of the energy storage cell 100.

On the lower end face of the energy storage cell 100 shown in FIG. 3B, the safety functions of the cell against overpressure can be seen. The primary protection device is formed by the metallic membrane 114, which closes a central circular aperture 101b in the housing bottom 101a. The secondary protection device is formed by the grooves 101c, whereby one of the three star-shaped grooves 101c can be seen in section in this illustration. The grooves 101c, which are located on the inside of the housing bottom 101a, represent a defined weakening structure of the housing bottom, so that in the event of a relatively high overpressure occurring inside the cell, these structures can open and gas can escape.

The preferred design of the energy storage cell 100, illustrated with reference to FIG. 3, allows a reduced number of parts in the upper region of the energy storage cell (FIG. 3A), with the negative and positive terminals of the cell being arranged in this upper region. In particular, this design makes it possible to dispense with additional arresters due to the one-piece design of the connection pole 102b.

The direct contacting of the longitudinal edge of one of the electrode bands on the side of the housing bottom (sub-figure 3B) also serves to make the cell particularly compact, so that no dead volumes are required for the various functions of the cell.

Direct contact between the longitudinal edges of the electrode ribbons also improves heat dissipation and reduces internal resistance.

In addition, the design of this cell generally also allows the formation of longer windings and thus a greater energy density of the resulting energy storage cell.

The upper end face of the energy storage cell 100 is maximally compact in this design. If any gases are generated inside the cell that lead to an increase in pressure, these gases are inevitably directed into the lower region of the cell, in which the safety functions for pressure equalization are arranged. Overall, such a cell therefore has a very good level of safety.

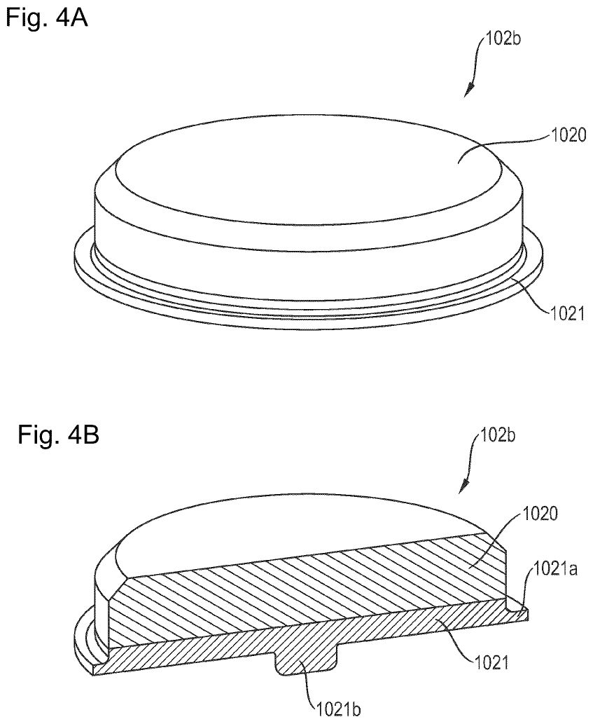

FIG. 4A,B shows a detailed representation of the connecting pole 102b in an oblique view from above (FIG. 4A) and in a sectional view (FIG. 4B). In this preferred embodiment, the connecting pole 102b is composed of two metallic components. The upper region (upper pole portion) 1020 is preferably formed of aluminum and the lower region (lower pole portion) 1021 is preferably formed of copper. The upper region 1020 has a beveled, circumferential upper edge. As can be seen in the sectional view according to FIG. 4B, the lower region 1021 has an externally circumferential welding shoulder 1021a and a central, downwardly projecting pin 1021b. The pin 1021b expediently engages in a correspondingly provided depression in the center of the contact sheet metal part 111 and thus ensures a good fit of the connection pole 102b.

Such a connection pole 102b can, for example, be formed from a bi-metal strip with aluminum and copper. For example, a blank is punched out of the bi-metal for this purpose. The upper region 1020 with the beveled edge and the lower region 1021 with the central pin 2021b and the circumferential welding shoulder 1021a can be formed by cold forming.

Copper is suitable for the lower region 1021 of the connection pole 102b, in particular for cases in which the connection pole 102b is intended for contacting an anode current collector via the contact sheet metal part 111. The anode current collector also usually consists of copper, so that this material is also suitable for the connection pole. In this case, the contact sheet metal part 111 also preferably consists of copper.

The formation of the upper part 1020 of the connection pole 102b from aluminum has the particular advantage that in this case the entire housing of the energy storage cell can be formed from aluminum, since generally the cup-shaped housing part 101 also consists of aluminum. The cathode current collector, which may be electrically contacted with the housing bottom 101a, also often consists of aluminum. If the energy storage cell 100 is constructed with reversed polarity if necessary, it is of course also possible that the metallic materials for the housing and/or the connection pole are selected differently.

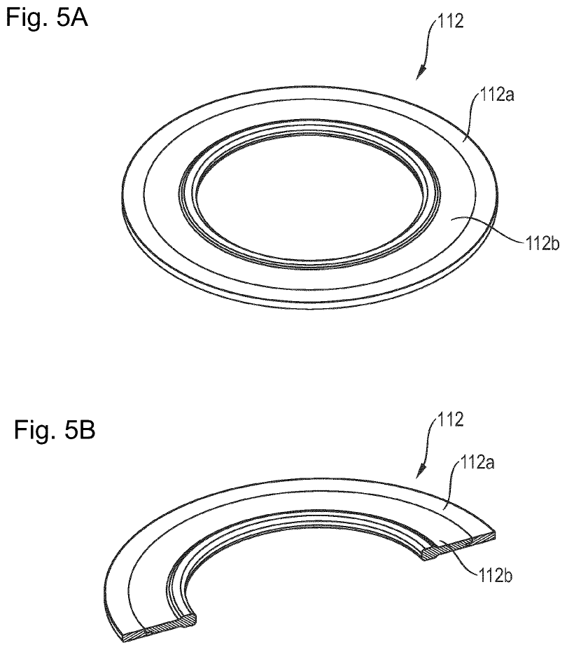

FIG. 5A,B shows the O-ring-shaped insulating disk 112 in a complete view oblique from above (FIG. 5A) and in a sectional view (FIG. 5B). On the one hand, the insulating disk 112 has the function of electrically insulating the preferably positively polarized lid plate 102a from the components of the energy storage cell 100 with negative polarity. In addition, a liquid-tight and airtight closure of the housing is also achieved by the insulating disk 112.

In the preferred example of the insulating washer 112 shown here, the insulating washer is made of two different materials. The outer region 112a of the insulating disk 112 is preferably formed from a strong plastic material, for example PBT (polybutylene terephthalate). The inner region 112b is preferably formed from a somewhat more flexible and, in particular, from a heat-resistant plastic material, for example PET (polyethylene terephthalate). The outer region 112a thus ensures particular mechanical stability. The inner region 112b ensures flexibility and is resistant to the hot potting compound 13 to be applied during assembly of the energy storage cell.

With particular advantage, the inner circumference of the O-ring-shaped insulating disk 112 has a circumferential thickening, which further supports the stability of the components in the end face region of the mounted energy storage cell.

When assembling the energy storage cell, inserting the insulating washer 112 in the lid area of the cell initially achieves a temporary sealing of the cell until the subsequently applied potting compound 113 has hardened to completely seal the cell. Furthermore, due to its special shape, the insulating disk 112 allows axial support of the winding-shaped electrode-separator assembly 104, for example when testing the cell. If the cell is deformed laterally, the shape of the insulating disk 112 also provides space for any deformation of the contact sheet metal part 111 that may occur. Finally, the shape of the insulating disk 112 makes it possible to reduce the volume of the potting compound 113 and the amount of air bubbles that may be trapped during potting when the energy storage cell is assembled.

As a possible alternative to such an insulating washer, for example, an insulating sealing bulge, comparable to a silicone bulge, can be dosed on. This can also ensure a tight seal. However, the insulating washer 112, in particular in the embodiment illustrated here, offers the various advantages mentioned in comparison.

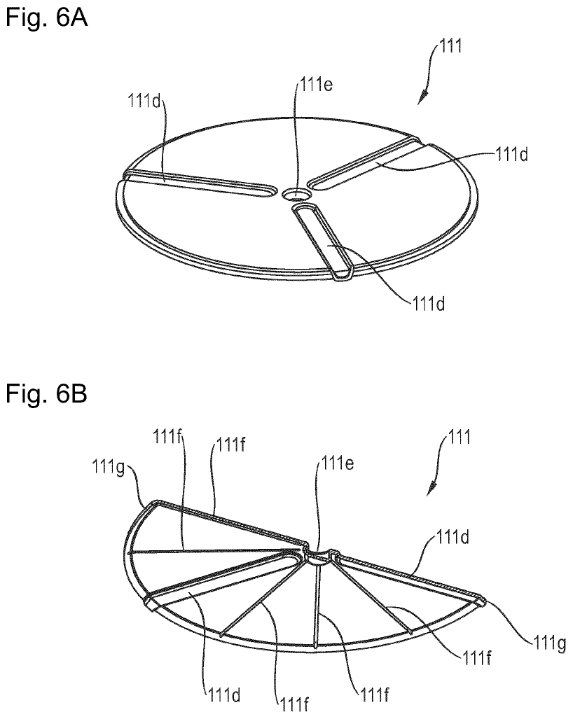

FIG. 6A,B shows a preferred embodiment of the contact sheet metal part 111, which is provided for contacting the free edge of the current collector of the respective electrode in a range from the upper region of the energy storage cell. FIG. 6A shows a top view of the disk-shaped contact sheet metal part 111. FIG. 6B shows a section through the contact sheet metal part 111 in a view from below, i.e. on that side of the contact sheet metal part which faces the electrode-separator assembly inside the energy storage cell.

Similar to the beads 101d of the housing bottom 101a, the contact sheet metal part 111 also has three star-shaped beads 111d, which appear on the outside (FIG. 6A) as a depression and on the inside (FIG. 6B) as an elongated elevation. The beads 111d can be embossed, for example, and have a depth of 0.25 mm, for example. In the assembled state of the cell, the beads 111d are in contact with the respective longitudinal edge of an electrode strip of the electrode-separator assembly to be contacted via this. The contact sheet metal part 111 is preferably welded to the respective longitudinal edge of the electrode strip via the beads 111d.

A depression 111e is located in the center of the contact sheet metal part 111. The depression 111e serves to receptable the connecting pole 102b, in that the central pin 1021b of the connecting pole 102b engages in the depression 111e. In this way, the connecting pole 102b can be easily positioned and fixed on the contact sheet metal part 111 so that the connecting pole 102b can be welded on without any problems.

Furthermore, in the preferred embodiment of the contact sheet metal part 111 shown here, further star-shaped narrow depressions 111f are provided, which are located on the inward-facing side of the contact sheet metal part 111. In this example embodiment, a total of nine of these depressions 111f are provided as narrow grooves arranged in a star shape. The grooves can have a depth of 0.1 mm, for example. The depression 111f channels serve to improve the distribution of the electrolyte within the cell.

Furthermore, in this preferred embodiment, the contact sheet metal part 111 has an embossed circumferential edge 111g, which is arranged as a predetermined buckling point, in particular with the ridge facing downwards. This predetermined buckling point facilitates the assembly of the housing of the energy storage cell.

In preferred embodiments, the contact sheet metal part 111 is made of sheet copper, for example of a sheet copper with a material thickness of 0.3 mm. Copper is advantageous in cases in which the contact sheet metal part is in contact with the longitudinal edge of the anode current collector, which is also preferably formed from copper.

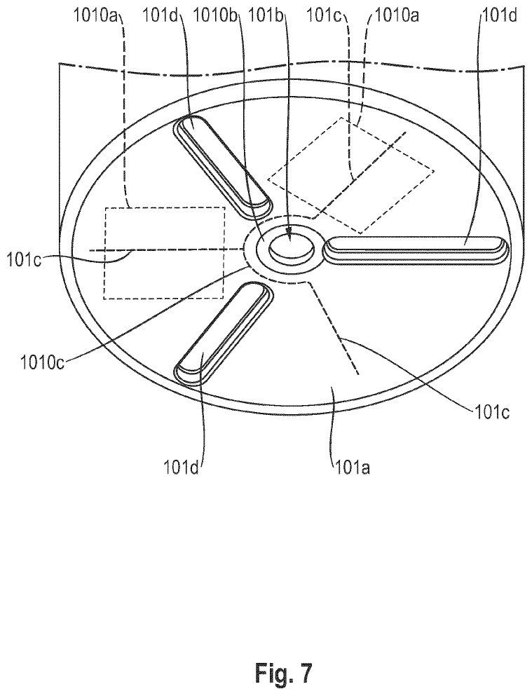

FIG. 7 shows a detailed view of the housing bottom 101a of the energy storage cell with the star-shaped, inwardly projecting beads 101d, which are designed in particular as weld embossings for contacting the winding-shaped electrode-separator assembly. The star-shaped arrangement with three beads 101d is advantageous for mounting the cell due to its rotational symmetry.

The central aperture 101b in the housing bottom 101a is covered by a metallic membrane 114 and serves as primary protection device for the cell in the event of overpressure occurring. In particular, it is intended that the aperture 101b is first used to fill the cell with electrolyte during production of the cell before the aperture 101b is closed with the metallic membrane 114.

For a precisely fitting receptable of the metallic membrane 114 for closing the central aperture 101b, a circumferential depression 1010b is preferably provided, which surrounds the central aperture 101b.

Furthermore, in this embodiment, three star-shaped weakening structures are provided in the form of the inwardly open grooves 101c, which are interconnected by a semicircular connecting line 1010c. These weakening structures 101c and 1010c serve as secondary protection device against internal overpressure. As an alternative to attaching the weakening structures to the housing bottom from the inside, such weakening structures, for example scoring lines, can also be attached from the outside.

One or more labeling fields 1010a may further be provided on the outside of the housing bottom 101a, which may be used for affixing various written information.

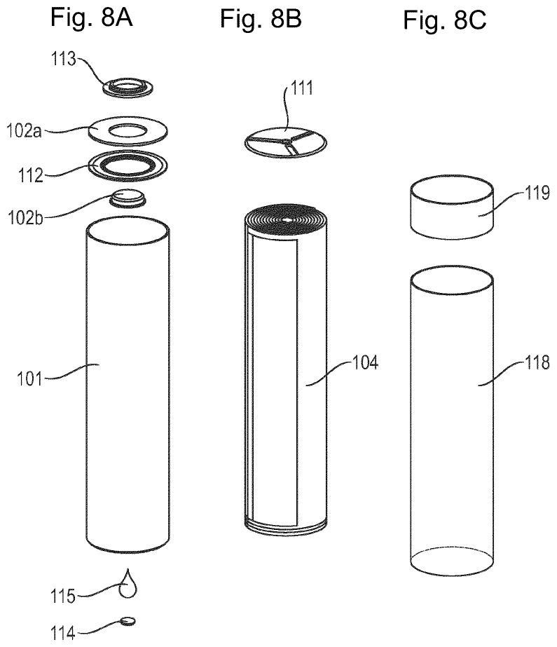

FIGS. 8 to 10 below illustrate various details in connection with the manufacture of the energy storage cells.

FIGS. 8A-C show exploded views of the various components of an energy storage cell. FIG. 8A shows the components of the housing with the housing cup 101, the connection pole 102b, the O-ring-shaped insulating washer 112, the lid plate 102 with the central recess into which the connection pole 102b engages, and the potting compound 113. The closure for the energy storage cell in the form of the metallic membrane 114 is shown below the housing cup 101, this closure being attached after the assembled cell has been filled with the electrolyte 115 schematically indicated here.

FIG. 8B shows the winding-shaped electrode-separator assembly 104 and the contact sheet metal part 111 to be attached thereto. The winding-shaped electrode-separator assembly 104 can be produced in a manner known per se by winding the electrode ribbons and the separators, in particular on a winding machine. To complete the winding shape, the outermost winding turn can be bent inwards by 30° to 45°, for example, in a preferred manner using a conical pressure piece, so that the winding shape is stabilized. An adhesive tape 118 (FIG. 8C), for example made of polypropylene, is then preferably applied to the outer circumferential surface of the winding, which, in addition to the stabilizing function, may also have an electrically insulating function in the cell. After this stabilization of the winding-shaped electrode-separator assembly 104, the disc-shaped contact sheet metal part 111, which is formed from copper, for example, can be placed loosely on the upper end face of the winding and fixed in place with a stable adhesive tape 119 made from polyimide, for example. For example, a tape made of Kapton® with a thickness of 50 μm can be used for this purpose.

The electrode-separator assembly 104 with the attached contact sheet metal part 111 is then inserted into the cup-shaped housing part 101. After aligning the beads in the housing bottom and in the contact sheet metal part, if necessary with the aid of a camera, the arrangement can be pressed using suitable pressing tools and laser-welded simultaneously or sequentially from above and below to contact the longitudinal edges of the electrode ribbons with the respective beads. The connecting pole 102b can then be placed on the contact sheet metal part 111 and welded on.

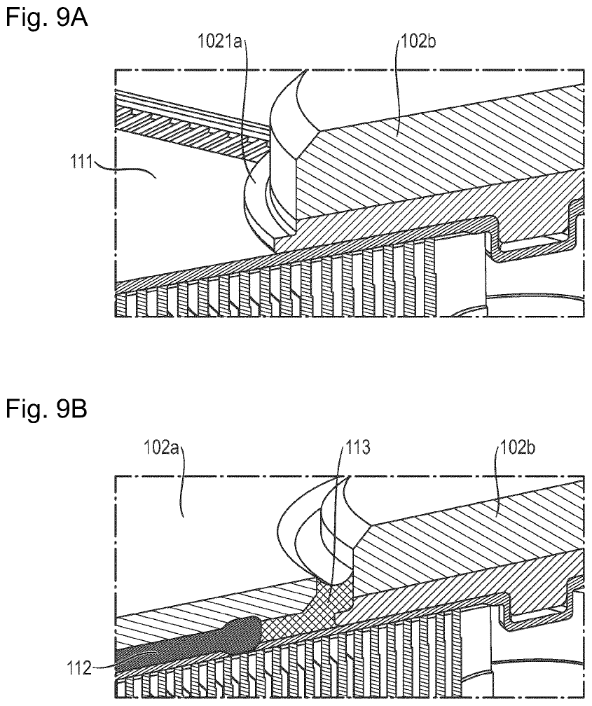

FIG. 9A,B shows details of the production of the lid assembly of the cell. FIG. 9A shows a detailed view of the welding of the connection pole 102b onto the contact sheet metal part 111, whereby the laser can be applied obliquely or vertically, in particular in the region of the circumferential welding shoulder 1021a of the connection pole 102b. FIG. 9B shows how the insulating disk 112 can then be inserted and pressed to the correct height before the lid plate 102a is placed and welded from an angle, vertically or horizontally to the cup-shaped housing part not shown here. Now the connecting pole 102b can be pressed to the correct height in relation to the cell shoulder formed by the upper side of the lid plate 102a, if necessary. The distance provided for this can be, for example, 1 mm between the top side of the connection pole 102b and the top side of the lid plate 102a. The gap between the lid plate 102a and the connection pole 102b is filled with a potting compound 113 in order to seal this part of the energy storage cell in an airtight and liquid-tight manner.

The energy storage cell can then be placed in an oven to set the potting compound 113 and heat out the residual moisture of the winding-shaped electrode-separator assembly.

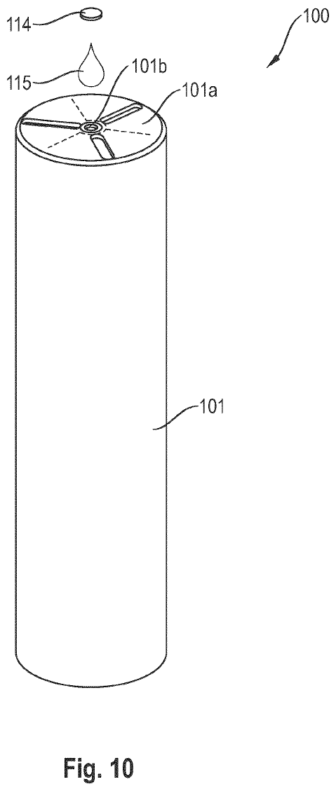

FIG. 10 illustrates the final filling with electrolyte 115, which is filled from the bottom side of the energy storage cell 100 (at the top in this illustration) through the aperture 101b in the housing bottom 101a. Finally, the metallic membrane 114 is applied as a closure to the opening in the housing bottom 101a or as a closure to the central aperture 101b. A vertical laser beam can be used for this purpose, for example.

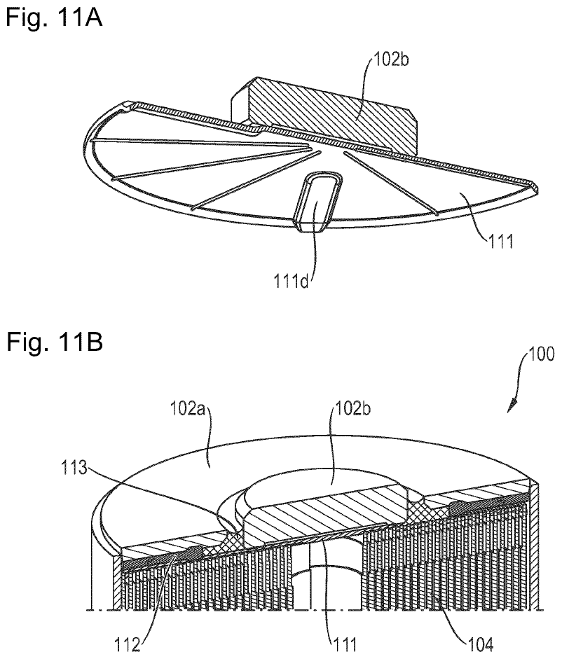

FIG. 11 illustrates an alternative way of mounting the lid assembly. FIG. 11A shows the contact sheet metal part 111 with the connecting terminal 102b attached to it in a sectional view from below. FIG. 11B shows the upper end face area of the cell in a longitudinal section.

In this alternative manufacturing process, the connecting pole 102b is welded to the contact sheet metal part 111 in advance. Friction welding or friction stir welding can be used for this.

When the contact sheet metal part 111 is designed in this embodiment, the star-shaped beads 111d of the contact sheet metal part 111 can be shortened if necessary, as they are covered by the connecting pole 102b during the subsequent welding of the electrode-separator assembly. Overall, therefore, slightly less welding area is available for contacting the longitudinal edge of the respective electrode strip with the contact sheet metal part 111. However, this configuration can offer advantages for assembly.

Since it may be easier to attach the connection pole 102b directly to the contact sheet metal part 111 outside the housing cup assembly, a central depression in the contact sheet metal part and a corresponding pin on the connection pole 102b can be dispensed with if necessary.

The further assembly of the energy storage cell with the connection pole 102b, which is already welded directly onto the contact plate 111, does not differ in principle from the previously described manufacturing process for the energy storage cell 100.

### Various Aspects

The individual elements of an energy storage element, which are explained here in detail, can in principle be realized independently of one another as separate aspects.

According to a first aspect, the disclosure relates to an energy storage element with an electrode-separator assembly and a metallic housing cup. The electrodes of the electrode-separator assembly are preferably in direct electrical contact with a contact sheet metal part on one end face of the energy storage element and with the housing bottom on the other end face of the energy storage element via one of their longitudinal edges. This energy storage element is characterized by the primary protection device explained in detail and the secondary protection device in the housing bottom.

According to a further aspect, the disclosure comprises an energy storage element with an electrode-separator assembly and a metallic housing cup. The electrodes of the electrode-separator assembly are preferably in direct electrical contact with a contact sheet metal part on one end face of the energy storage element and with the housing bottom on the other end face of the energy storage element via one of their longitudinal edges in each case. This energy storage element is further characterized by the fact that a lid component with a metallic lid plate and a connection pole are provided in a compact design. Preferably, the connection pole forms the negative pole and the lid plate forms the positive pole of the element. The connection pole is preferably formed by two metallic components that are assembled together as a bi-metal. This connection pole is preferably realized according to the design explained with reference to FIG. 4.

According to a further aspect, the disclosure comprises an energy storage element with an electrode-separator assembly and a metallic housing cup. The electrodes of the electrode-separator assembly are preferably in direct electrical contact with a contact sheet metal part on one end face of the energy storage element and with the housing bottom on the other end face of the energy storage element via one of their longitudinal edges in each case. This energy storage element is further characterized by the fact that an O-ring-shaped insulating washer is provided to seal the connection pole against the other components of the element with opposite polarity. Preferably, this insulating disk is formed from two plastic components. In particular, the insulating washer is characterized by the features according to the embodiment explained with reference to FIG. 5.

According to a further aspect, the disclosure comprises an energy storage element with an electrode-separator assembly and a metallic housing cup. The electrodes of the electrode-separator assembly are preferably electrically contacted via one of their longitudinal edges directly on one end face of the energy storage element with a contact sheet metal part and on the other end face of the energy storage element with the housing bottom. This energy storage element is further characterized by the fact that the contact sheet metal part has no aperture. Additionally or alternatively, in a preferred embodiment, the contact sheet metal part has a central depression which serves to position a connection pole to be attached to this contact sheet metal part. Alternatively or additionally, the contact sheet metal part is equipped with at least one channel-shaped depression which points into the interior of the energy storage element equipped therewith and which is provided for optimized electrolyte distribution within the element. In a preferred manner, this contact sheet metal part is characterized by the features that were explained in more detail with reference to FIG. 6.

According to a further aspect, the disclosure comprises an energy storage element with an electrode-separator assembly and a metallic housing cup. The electrodes of the electrode-separator assembly are preferably in direct electrical contact with a contact sheet metal part on one end face of the energy storage element and with the housing bottom on the other end face of the energy storage element via one of their longitudinal edges in each case. This energy storage element is further characterized by the fact that a potting compound is provided to seal the polarities of the element that are guided to the outside against each other, which is introduced into a gap that is located between a connection pole of the element and the inner edge of a lid plate with a central aperture during the assembly of the cell. The connecting pole engages in the central aperture of the lid plate. The connecting pole forms one polarity and the surrounding lid plate forms the opposite polarity of the element. In preferred embodiments of this aspect, the element is characterized by the features explained with reference to FIG. 3 and FIG. 9 and, optionally alternatively, by the features explained with reference to FIG. 11.

Such potting for sealing and electrically insulating an energy storage element is advantageous in combination with a compact design in a range from the lid assembly of the element. In this context, a contact sheet metal part that has no apertures is also advantageous, for example a contact sheet metal part according to the embodiment shown in FIG. 3 with a central depression or according to the embodiment shown in FIG. 11 without a central depression.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage element, comprising:
an airtight and liquid-tight housing, comprising:
a metallic, cup-shaped housing part with a housing bottom, a circumferential side wall, and a terminal opening,
a lid component that closes the terminal opening of the cup-shaped housing part, the lid component comprising a metallic lid plate and a connecting terminal guided through an aperture in the lid plate and electrically insulated from the lid plate,
an electrode-separator assembly arranged in the housing, the electrode-separator assembly comprising a first flat terminal end face, a second flat terminal end face, an anode with an anode current collector having a first edge and a second edge parallel thereto, and a cathode with a cathode current collector having a first edge and a second edge parallel thereto; and
a contact sheet metal part that sits directly on the first edge of the anode current collector or on the first edge of the cathode current collector, the contact sheet metal part being electrically connected to the connecting terminal,
wherein the anode current collector comprises a main region loaded with a layer of negative electrode material and a free edge strip, extending along the first edge of the anode current collector, that is not loaded with the negative electrode material,
wherein the cathode current collector comprises a main region loaded with a layer of positive electrode material and a free edge strip, extending along the first edge of the cathode current collector, that is not loaded with the positive electrode material,
wherein the anode and the cathode are arranged within the electrode-separator assembly such that the first edge of the anode current collector protrudes from the first terminal end face and the first edge of the cathode current collector protrudes from the second terminal end face,
wherein the first edge of the cathode current collector or the first edge of the anode current collector, which is not in direct contact with the contact sheet metal part, is electrically connected to the housing bottom,
wherein the housing bottom has an aperture closed by a metallic membrane that acts as a primary protection device against internal overpressure, and
wherein the housing bottom has at least one groove on its inside or outside that acts as a secondary protection device against internal overpressure.

2. The energy storage element according to claim 1, wherein at least one of:
the cup-shaped housing part is electrically connected to the cathode;
the contact sheet metal part sits on the first edge of the anode current collector and is connected to it by welding;
the cup-shaped housing part comprises aluminum or an aluminum alloy;
the lid plate comprises aluminum or an aluminum alloy; and/or
the contact sheet metal part is in direct contact with the connecting terminal.

3. The energy storage element according to claim 1, wherein at least one of:
the cup-shaped housing part is electrically connected to the anode;
the contact sheet metal part sits on the first edge of the cathode current collector and is connected to it by welding;
the cup-shaped housing part comprises copper or nickel or a copper or nickel alloy or steel or nickel-plated steel;
the lid plate comprises copper or nickel or a copper or nickel alloy or steel or nickel-plated steel; and/or
the contact sheet metal part is in direct contact with the connecting terminal.

4. The energy storage element according to claim 1, wherein at least one of:
the housing bottom has at least one bead that appears on its outer side as an elongate depression and on its inner side as an elongate elevation, the first edge of the anode current collector or the first edge of the cathode current collector resting on the inner side;
the housing bottom is welded to the first edge of the anode current collector or the first edge of the cathode current collector in the region of the bead;
the aperture is positioned in the center of the housing bottom;
the at least one bead comprises several linear beads arranged in a star-shaped arrangement around the aperture;
the at least one groove comprises several linear partial sections arranged in a star-shaped arrangement around the aperture; and/or
the at least one groove comprises a partial section running around the aperture that connects the linear partial sections arranged in a star shape.

5. The energy storage element according to claim 1, wherein at least one of:
the connecting pole sits directly on the contact sheet metal part and is connected to it by welding;
the connecting terminal is electrically insulated from the lid plate by a hardened potting compound made of an electrically insulating plastic material;
an annular gap between the lid plate and the contact sheet metal part is filled with the potting compound; and/or
the annular gap is bounded radially outwards by an O-ring-shaped insulating washer made of an electrically insulating plastic material.

6. The energy storage element according to claim 1, wherein at least one of:
the connecting pole sits directly on the contact sheet metal part and is connected to it by welding;
the contact sheet metal part consists of nickel or copper or titanium or a nickel or copper or titanium alloy or stainless steel;
the connecting terminal is a bimetallic connecting terminal and comprises a pole lower part made of nickel or copper or titanium or a nickel or copper or titanium alloy or stainless steel and a pole upper part made of aluminum or an aluminum alloy;
the lower part of the pole is welded to the contact sheet metal part; and/or
the lower part of the pole and the contact sheet metal part and the anode current collector comprise the same material.

7. The energy storage element according to claim 3, wherein at least one of:
the connecting terminal sits directly on the contact sheet metal part and is connected to it by welding;
the contact sheet metal part comprises aluminum or an aluminum alloy;
the connection pole comprises aluminum or an aluminum alloy;
the contact sheet metal part and the connecting pole and cathode current collector comprise the same material.

8. The energy storage element according to claim 1, wherein at least one of:
the contact sheet metal part has a uniform thickness in a range of 50 μm to 600 μm;
the contact sheet metal part has two opposite flat sides and extends essentially in only one dimension;
the contact sheet metal part is a disk or a polygonal plate;
the contact sheet metal part is dimensioned such that it covers at least 40% of the end face from which the edge of the current collector on which it rests protrudes;
the contact sheet metal part has at least one bead, which appears on one flat side of the contact sheet metal part as an elongate depression and on the opposite flat side as an elongate elevation, the contact sheet metal part rests with the flat side, which bears the elongate elevation, on the first edge of the anode current collector or on the first edge of the cathode current collector; and/or
the contact sheet metal part is welded in the region of the bead to the first edge of the anode current collector or the first edge of the cathode current collector.

9. The energy storage element according to claim 1, wherein the metallic membrane is fixed by welding to the bottom of the cup-shaped housing part.

10. A method of manufacturing an energy storage element according to claim 1, the method comprising:
a providing the metallic, cup-shaped housing part;
providing the electrode-separator assembly;
inserting the electrode-separator assembly into the housing cup so that the first edge of the anode current collector or the first edge of the cathode current collector rests on the housing bottom; and
forming a welded connection between the first edge resting on the housing bottom and the housing bottom.

11. The method according to claim 10, further comprising at least one of:
positioning the contact sheet metal part on a respective edge, the respective edge being the first edge of the anode current collector or the first edge of the cathode current collector which does not rest on the housing bottom, and connecting the contact sheet metal part to the respective edge by welding and/or
fixing the connection terminal to the contact sheet metal part.

12. The method of manufacturing an energy storage element according to claim 11, further comprising:
inserting the lid plate into the terminal opening of the cup-shaped housing part; and
filling a gap remaining between the lid plate and the contact sheet metal part with a potting compound which, when hardened, electrically insulates the lid plate from the connecting terminal and from the contact sheet metal part.
